(19) United States
(12) Patent Application Publication
(10) Pub. No.: US 2019/0308834 A1
(43) Pub. Date: Oct. 10, 2019

(54) REGISTRATION SYSTEM WITH OMNI WHEELS

(71) Applicant: Xerox Corporation, Norwalk, CT (US)

(72) Inventors: Michael J. Linder, Walworth, NY (US); Carlos M. Terrero, Ontario, NY (US); Roberto A. Irizarry, Rochester, NY (US); Jeffrey N. Swing, Rochester, NY (US)

(21) Appl. No.: 15/948,524

(22) Filed: Apr. 9, 2018

(51) Int. Cl. B65H 9/00; B41J 11/00; B41J 13/00; B41J 13/03; B41J 13/076; B65H 9/20; B65H 5/06

(52) U.S. Cl. CPC B65H 9/002; B41J 11/0095; B41J 11/0055; B65H 5/062; B41J 13/03; B41J 13/076; B65H 9/20; B41J 13/0018

(57) ABSTRACT

A registration system for a printing device and a method for controlling the same are disclosed. For example, the registration system includes at least one sensor, omni wheels, a motor coupled to each omni wheel, and a processor communicatively coupled to the at least one sensor, and the motors, wherein the processor calculates a desired movement to move the omni wheels based on the position of the print media.

The present disclosure relates generally to printing devices and, more particularly, to registration systems with omni wheels.

### BACKGROUND

Printing devices can be used to print images on print media. The print media can be fed through the printing device along a transport path and imaging path to have the image printed. Along the transport path and the imaging path, there are certain locations where processing errors can occur that can cause a misalignment of the image relative to the print media.

For example, the printing devices can have a registration system. The registration system may be responsible for correctly feeding the print media to an imaging system such that the printed image is correctly aligned with the print media. As the size and weight of print media grows larger and larger, it can be more and more difficult for currently designed registration systems to handle the larger print media.

### SUMMARY

According to aspects illustrated herein, there are provided a registration system for a printing device and a method for controlling the same. One disclosed feature of the embodiments is a registration system for a printing device comprising at least one sensor to detect a position of a print media, a first omni wheel and a second omni wheel arranged such that a respective center axis of rotation of the first omni wheel and the second omni wheel are perpendicular to a process direction, a first motor coupled to first omni wheel and a second motor coupled to the second omni wheel, a third omni wheel and a fourth omni wheel arranged such that a respective center axis of rotation of the third omni wheel and the fourth omni wheel are parallel to the process direction, a third motor coupled to the third omni wheel and a fourth motor coupled to the fourth omni wheel, and a processor communicatively coupled to the at least one sensor, the first motor, the second motor, the third motor, and the fourth motor, wherein the processor calculates a desired movement of the first motor, the second motor, the third motor, and the fourth motor to move the first omni wheel, the second omni wheel, the third omni wheel, and the fourth omni wheel based on the position of the print media.

Another disclosed feature of the embodiments is a method for controlling a position of a print media in a registration system of a printing device. In one embodiment, the method detects a position of a print media, determines a desired movement of a first omni wheel, a second omni wheel, a third omni wheel, and a fourth omni wheel based on the position of the print media, wherein the first omni wheel and the second omni wheel rotate in a process direction and the third omni wheel and the fourth omni wheel rotate perpendicular to the process direction, and moves the first omni wheel, the second omni wheel, the third omni wheel, and the fourth omni wheel in accordance with the desired movement to adjust the position of the print media.

### BRIEF DESCRIPTION OF THE DRAWINGS

The teaching of the present disclosure can be readily understood by considering the following detailed description in conjunction with the accompanying drawings, in which:

FIG. 1 illustrates a block diagram of example printing device of the present disclosure;

FIG. 2 illustrates a cross-sectional view in a process direction of an example system using omni wheels of the present disclosure;

FIG. 3 illustrates a top view of an example registration system using omni wheels of the present disclosure;

FIG. 4 illustrates a cross-sectional view in a process direction of an example system using omni wheels of the present disclosure;

FIG. 5 illustrates a flowchart of an example method for controlling a position of a print media in a registration system of a printing device via at least one omni wheel; and

FIG. 6 illustrates a high-level block diagram of an example computer suitable for use in performing the functions described herein.

To facilitate understanding, identical reference numerals have been used, where possible, to designate identical elements that are common to the figures.

### DETAILED DESCRIPTION

The present disclosure is related to a registration system having omni wheels and a method for registering a print media using the omni wheels. As discussed above, printing devices can have a registration system. The registration system may be responsible for correctly feeding the print media to an imaging system such that the printed image is correctly aligned with the print media. As the size and weight of print media grows larger and larger, it can be more and more difficult for currently designed registration systems to handle the larger print media.

Registration systems may include center registered systems and edge registered systems. Current designs for some registration systems require the use of three nips and/or a movable registration carriage. The movable registration carriage may help adjust for lateral input error.

A center nip may be vertically movable (e.g., up and down). As a result, for smaller sheets of print media, the center nip may be moved down to engage the print media. For larger sheets of print media, the center nip may be moved up to disengage the print media and allow the outer two nips to engage the print media. Engaging and disengaging the nips may be inefficient.

Embodiments of the present disclosure provide a registration system that uses omni wheels to correct various alignment errors, such as lateral input errors, skew, and the like. The omni wheels provide greater directional control of the print media within the registration system and simplify the components within the registration system. For example, the movable registration carriage may be replaced with the omni wheels. The omni wheels may provide skew correction and lateral position correction.

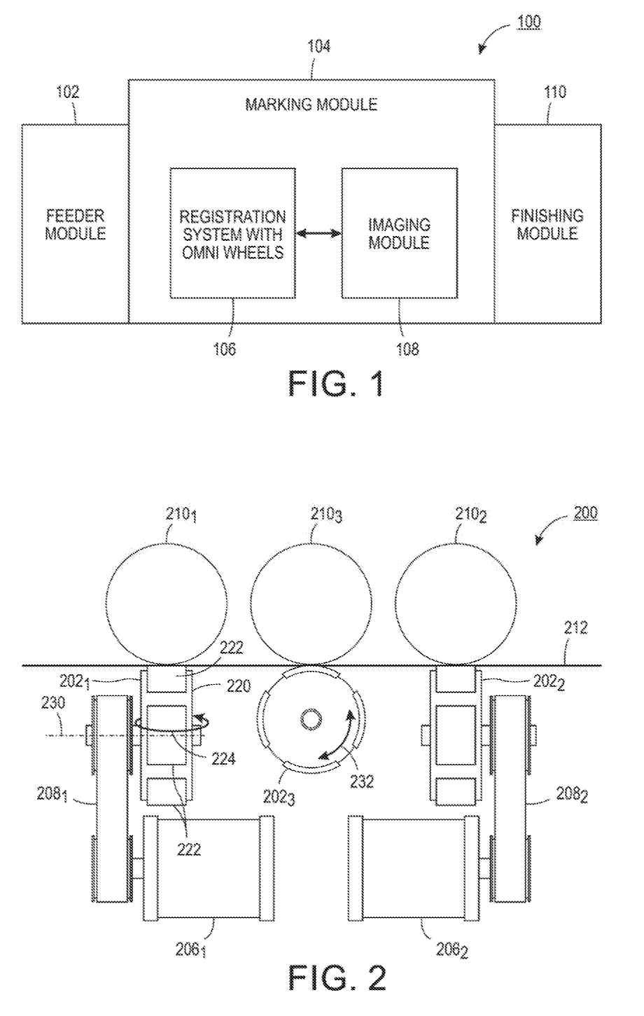

FIG. 1 illustrates a block diagram of an example printing device 100 of the present disclosure. The printing device 100 may be any type of printing device such as a multi-function device (MFD), a copy machine, laser printer, an ink jet printer, and the like.

In one embodiment, the printing device 100 may include a feeder module 102, a marking module 104, and a finishing module 110. The feeder module 102 may include feeder trays that feed print media through the printing device 100.

The marking module 104 may include a registration system 106 with omni wheels, as discussed in further details below, and an imaging module 108. The registration system 106 may be used to align print media such that an image is correctly printed on print media that is fed through the printing device 100. In other words, the registration system 100 may correctly align and position the print media relative to an imaging module 108 that is further downstream from the registration system 106.

The imaging module 108 may print a desired image onto the print media. The imaging module 108 may use any type of printing means to print the desired image. For example, the imaging module 108 may include an imaging belt that transfers toner that is dispensed onto the imaging belt onto the print media. In another example, the imaging module 108 may include ink jet print heads that print a desired image onto the print media, and the like.

The finishing module 110 may perform any final processing of the print media after the desired image is printed. For example, the final processing may include, stacking, stapling, collating, organizing, and the like, the print media with the desired printed image.

It should be noted that the printing device 100 has been simplified for ease of explanation. The printing device 100 may include additional modules or components that are not shown. For example, the printing device 100 may include a graphical user interface (GUI), a digital front end, a processor, a memory storing instructions that are executed by the processor, a duplex return path, and the like.

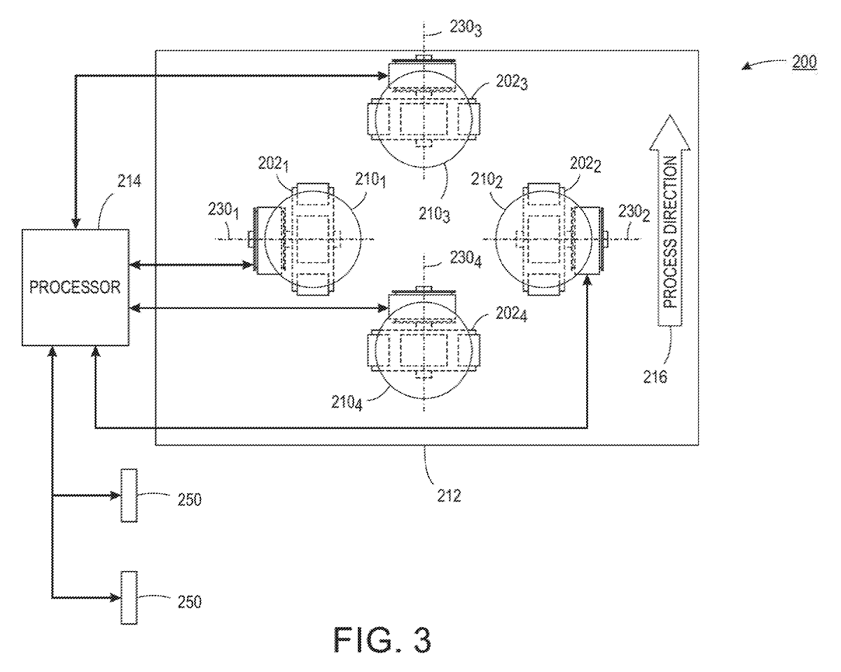

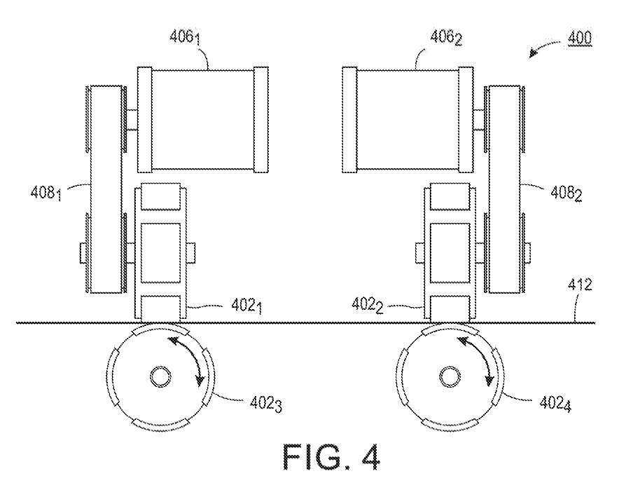

FIG. 2 illustrates a cross-sectional view of a front, or in a process direction, of an example system 200 that may be deployed in the registration system 106. In one embodiment, the system 200 may include omni wheels 202₁, 202₂, and 202₃. The system 200 may also include an optional fourth omni wheel 202₄ that is shown in FIG. 3, but not seen in the cross-sectional view of FIG. 2. The omni wheels 202₁, 202₂, 202₃, and 202₄ may also be referred to herein individually as an omni wheel 202 or collectively as omni wheels 202. Each omni wheel 202₁, 202₂, and 202₃ may be coupled to a respective motor (motors 206₁ are 206₂ are illustrated for omni wheels 202₁ and 202₂, respectively, where the motors 206₁ and 206₂ may also be referred to herein individually as a motor 206 or motors 206) via a belt (belts 208₁ and 208₂ are illustrated for omni wheels 202₁ and 202₂, respectively, where the belts 208₁ and 208₂ may also be referred to herein individually as a belt 208 or collectively as belts 208). It should be noted that the motors 206 and belts 208 corresponding to the third and fourth omni wheels 202₃ and 202₄ are not visible in the view of FIG. 4. It should be noted that the fourth omni wheel 202₄ may also be coupled to a respective motor via a belt similar to the omni wheels 202₁, 202₂, and 202₃.

Each omni wheel 202 may include a central body portion 220. The central body portion 220 may rotate around a central axis of rotation 230. The central body portion 220 may rotate around the central axis of rotation 230 as shown by the arrow 232.

Each omni wheel 202 may also include a plurality of roller components 222 coupled to an outer periphery of the central body portion 220. Each one of the plurality or roller components 222 may rotate around an axis that is perpendicular to the respective center axis of rotation 230. For example, if the omni wheel 202₁ rotates around the center axis of rotation 230, the plurality of roller components 222 may rotate around an axis that is perpendicular to the center axis of rotation 230 as shown by an arrow 224.

In one embodiment, the plurality of roller components 222 may have a cylindrical, a rounded cylindrical, or a spherical like shape and freely rotate in a direction as shown by the arrow 224. The plurality of roller components 222 may be spaced evenly apart around the outer periphery of the central body portion 220.

In one embodiment, the central body portion 220 and the plurality of roller components 222 may be comprised of any type of material. In one example, the central body portion 220 and the plurality of roller components 222 may be fabricated from a plastic or a rubber type material.

In one embodiment, the omni wheels 202 may be each located on a same side of a print media 212 that enters the registration system 106. For example, the omni wheels 202 may all be located below the print media 212.

In one embodiment, the omni wheels 202 may be positioned in opposing pairs. For example, the omni wheels 202₁ and 202₂ may be located across from one another. The omni wheels 202₁ and 202₂ may be aligned such that a center of the omni wheel 202₁ and a center of the omni wheel 202₂ share a same central axis of rotation 230.

The omni wheels 202₁ and 202₂ may be spaced apart by a distance that is approximately a width of the print media 212. In one embodiment, the width may be the smallest width of a print media 212 that may be fed in the printing device 100. For example, if the printing device 100 can handle print media having widths of 8.5 inches, 11 inches, and 14 inches, the omni wheels 202₁ and 202₂ may be spaced apart approximately 8.5 inches.

Similarly, the omni wheels 202₃ and 202₄ may be located across from one another. The omni wheels 202₃ and 202₄ may be aligned such that a center of the omni wheel 202₃ and a center of the omni wheel 202₄ share a same central axis of rotation 230.

The omni wheels 202₃ and 202₄ may be spaced apart by a distance that is approximately a length of the print media 212. In one embodiment, the length may be the shortest length of a print media 212 that may be fed in the printing device 100. For example, if the printing device 100 can handle print media having lengths of 11 inches, 14 inches, and 28 inches, the omni wheels 202₃ and 202₄ may be spaced apart approximately 11 inches.

In one embodiment, the omni wheels 202₁ and 202₂ may provide forward drive of the print media 212. The omni wheels 202₃ and 202₄ may provide lateral movement of the print media 212 and may replace the movable carriage in current designs of printing devices. Thus, the combination of the omni wheels 202₁, 202₂, 202₃, and 202₄ provide movement in all directions to allow correction of skew and lateral positioning of the print media 212.

In one embodiment, the system 200 may also include idler rollers 210₁, 210₂, 210₃, and 210₄ (shown in FIG. 3). Each idler roller 210₁, 210₂, 210₃, and 210₄ may be located above, or over, a respective omni wheel 202₁, 202₂, 202₃, and 202₄. The idler rollers 210₁, 210₂, 210₃, and 210₄ may be fabricated from any type of plastic or rubber material and may help to keep the print media 212 flat as the print media 212 is being moved by the omni wheels 202₁, 202₂, 202₃, and 202₄. The idler rollers 210₁, 210₂, 210₃, and 210₄ may have a spherical shape.

FIG. 3 illustrates a top view of the example system 200. FIG. 3 illustrates the example arrangement of the omni wheels 202 in opposing pairs. As discussed above, the omni wheels 202₁ and 202₂ may be aligned across from one another. In other words, a respective central axis of rotation 230₁ and 230₂ may be aligned with one another. Said another way, the respective central axis of rotation 230₁ and 230₂ may form a common center axis of rotation when the omni wheels 202₁ and 202₂ are aligned. In addition, the omni wheels 202₃ and 202₄ may be aligned across from one another. In other words, a respective central axis of rotation 230₃ and 230₄ may be aligned with one another. Said another way, the respective central axis of rotation 230₃ and 230₄ may form a common center axis of rotation when the omni wheels 202₃ and 202₄ are aligned. In one embodiment, the omni wheel 202₄ may be optional and only one omni wheel 202₃ that rotates around a central axis in the cross-process direction may be deployed.

In one embodiment, the system 200 may also include a processor 214 and one or more sensors 250. The processor 214 may be communicatively coupled to the sensors 250 and the motors 206.

In one embodiment, the sensors 250 may be located upstream from the omni wheels 202₁, 202₂, 202₃, and 202₄. In one embodiment, the sensors 250 may be charge coupled device (CCD) sensors, capacitive sensors, or any other type of sensor, or sensors, that can detect a skew and a lateral position of the print media 212.

In one embodiment, the print media 212 may move along a process direction 216. The print media 212 may move past, or over, the sensors 250 depending on where the sensors 250 are located. The sensors 250 may detect a position of the print media 212. In one embodiment, the position may include a skew and a lateral position of the print media 212. The skew and the lateral position of the print media 212 may be transmitted to the processor 214.

The processor 214 may then calculate a desired movement of the motors 206 based on the position of the print media 212. The desired movement may be to control the motors 206 such that the omni wheels 202 adjust a skew of the print media 212 to zero degrees. In other words, the print media 212 may be moved such that a leading edge of the print media 212 is perpendicular to the process direction 216.

The desired movement may also be to control the motors 206 such that the omni wheels 202 adjust a lateral position of the print media relative to a desired alignment position. For example, if the printing device 100 is an edge registered device, the amount of desired movement may be an amount to laterally move the print media 212 to the alignment edge. In another example, if the printing device 100 is a center registered device, the amount of desired movement may be an amount to laterally move (either inboard, or outboard) the print media 212 to the center of the system 200 or the center of the registration system 106.

In one embodiment, the desired movement may include a speed of rotation of the omni wheels 202₁, 202₂, 202₃, and 202₄. For example, omni wheels 202₁ and 202₂ may be rotated at different speeds to adjust a skew of the print media 212. In one embodiment, the omni wheels 202₃ and 202₄ may be rotated at the same speed to move the print media 212 laterally. In one embodiment, the speed of rotation of the omni wheels 202₁, 202₂, 202₃, and 202₄ may each be controlled differently to simultaneously adjust skew and the lateral position of the print media 212.

It should be noted that the system 200 may also include additional components not shown. For example, the system 200 may include additional nips upstream and downstream from the omni wheels 202₁, 202₂, 202₃, and 202₄.

FIG. 4 illustrates a cross-sectional view of a front, or in a process direction, of another example system 400 that can be deployed in the registration system 106. In one embodiment, the system 400 may also include four omni wheels 402₁, 402₂, 402₃, and 402₄ (also referred to herein individually as an omni wheel 402 or collectively as omni wheels 402) similar to the system 200.

The omni wheels 402₁, 402₂, 402₃, and 402₄ may be similar to the omni wheels 202₁, 202₂, 202₃, and 202₄ in all respects. For example, each omni wheel 404 may include a central body portion, a plurality of roller components along an outer periphery of the central body portion, and the like. Each omni wheel 402 may rotate around a respective central axis of rotation and the plurality of roller components may rotate around an axis that is perpendicular to the respective central axis of rotation, as described above. The omni wheels 402 may also each be coupled to a respective motor (e.g., 406₁ and 406₂ shown in FIG. 4 for the omni wheels 402₁ and 402₂) via a belt (e.g., 408₁ and 408₂ shown in FIG. 4 for the omni wheels 402₁ and 402₂).

The system 400 may also include a processor and a sensor. The sensor may be located upstream from the omni wheels 402 to detect a skew and a position of a print media 412. The processor may then control movement of the motors 406 to move the omni wheels 402 to adjust a skew and/or a lateral position of the print media 412.

However, the system 400 may differ from the system 200 in the way that the omni wheels 402₁, 402₂, 402₃, and 402₄ are arranged. In one embodiment, the system 400 may remove the idler rollers 210. Instead, the system 400 may have a first opposing pair of omni wheels 402 located on a first side of the print media 412 and a second opposing pair of omni wheels 402 located on a second side of the print media 412 that is opposite the first side.

For example, the omni wheels 402₁ and 402₂ may be located on a first side that is above the print media 412. The omni wheels 402₁ and 402₂ may provide a forward drive of the print media 412 in a process direction. The omni wheels 402₃ and 402₄ may be located on a second side that is below the print media 412. The omni wheels 402₃ and 402₄ may provide lateral movement of the print media 412.

In one embodiment, the omni wheel 402₁ may be located directly above or against the omni wheel 404₃. Similarly, the omni wheel 402₂ may be located directly above or against the omni wheel 404₄. As a result, the omni wheels 402₁, 402₂, 402₃, and 402₄ may be positioned to support the print media 412 as the print media 412 passes through the system 400.

Thus, the system 400 may also control motors 406 to move the omni wheels 402 in a desired movement to adjust a skew and/or a lateral position of the print media 412. Similar to the system 200, the desired movement may include a rotational speed of the omni wheels 402. The system 400 may also have a processor to calculate an amount of movement or a rotational speed of the omni wheels 402. The amount of movement, or rotational speed, may be to adjust a skew of the print media 412 to zero degrees and/or adjust a lateral position of the print media 412 to a desired alignment position.

It should be noted that the system 400 may also include additional components not shown. For example, the system 400 may include additional nips upstream and downstream from the omni wheels 402₁, 402₂, 402₃, and 402₄.

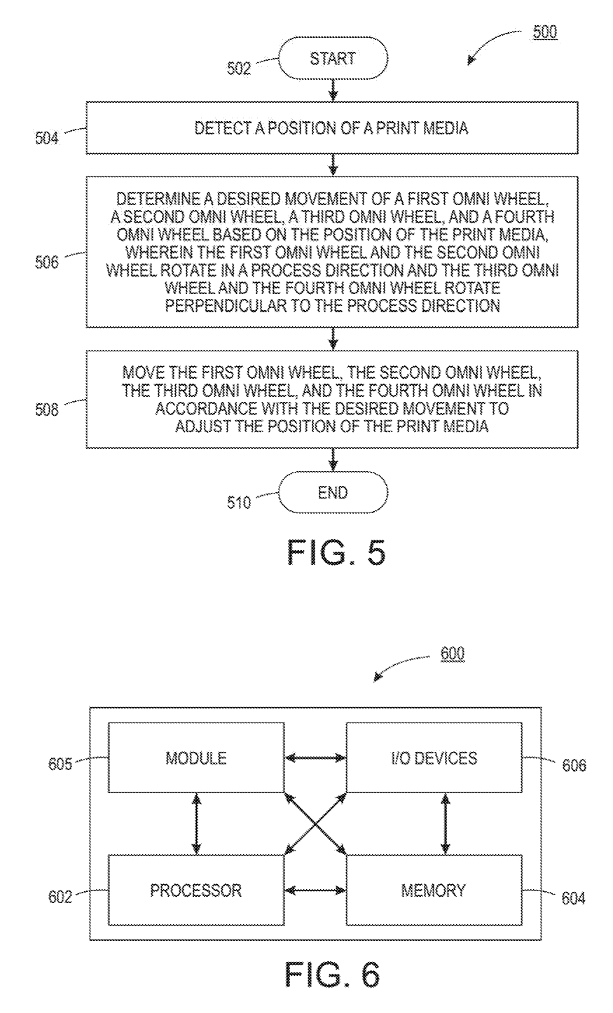

FIG. 5 illustrates a flowchart of an example method 500 for controlling a position of a print media in a registration system of a printing device via at least one omni wheel. In one embodiment, one or more steps or operations of the method 500 may be performed by the registration system 106 (e.g., using the system 200 or 400), or a computer/processor that controls operation of the registration system 106 as illustrated in FIG. 6 and discussed below.

At block 502, the method 500 begins. At block 504, the method 500 detects a position of a print media. In one embodiment, the print media may be any type of paper.

In one embodiment, one or more sensors may be deployed in the registration system to detect the position of the print media. The sensors may be CCD sensors, capacitive sensors, visual sensors, or any other type of sensor that can detect the position of the print media. The position may include a skew (e.g., an angle that the print media is tilted off of a straight line in the process direction) and a lateral position.

The lateral position may measure an amount that the print media is laterally away from a desired alignment position. For example, for a center registered system, the lateral position may include an amount and a direction (e.g., inboard or outboard) that the print media is off-center. For an edge registered system, the lateral position may include an amount of lateral movement away from the alignment edge.

At block 506, the method 500 determines a desired movement of a first omni wheel, a second omni wheel, a third omni wheel, and a fourth omni wheel based on the position of the print media, wherein the first omni wheel and the second omni wheel rotate in a process direction and the third omni wheel and the fourth omni wheel rotate perpendicular to the process direction. The first omni wheel, the second omni wheel, the third omni wheel, and the fourth omni wheel may be arranged in the system 200 or the system 400, as described above.

In one embodiment, the position of the print media may be used to determine the desired movement. For example, the print media may be laterally positioned 0.5 millimeters (mm) off of the registration edge and have a skew angle of 2 degrees towards the outboard side. The method 500 may determine the desired movement to adjust a position of the print media to move laterally towards the registration edge by 0.5 mm and adjust the skew angle back to 0 degrees.

In one embodiment, the desired movement of the first omni wheel, the second omni wheel, the third omni wheel, and the fourth omni wheel may include an rotational speed of the first omni wheel, the second omni wheel, the third omni wheel, and the fourth omni wheel. The omni wheels that are activated and the amount of rotational speed of the activated omni wheels may be based on the amount of movement needed to adjust the skew and the lateral position by a desired amount.

At block 508, the method 500 moves the first omni wheel, the second omni wheel, the third omni wheel, and the fourth omni wheel in accordance with the desired movement to adjust the position of the print media. In one embodiment, the first omni wheel, the second omni wheel, the third omni wheel, and the fourth omni wheel may be moved by activating a respective motor coupled to the first omni wheel, the second omni wheel, the third omni wheel, and the fourth omni wheel. Control of the motor may control the rotational speed of the first omni wheel, the second omni wheel, the third omni wheel, and the fourth omni wheel.

In one embodiment, the first omni wheel, the second omni wheel, the third omni wheel, and the fourth omni wheel may have different rotational speeds. For example, at least two different omni wheels may have a different rotational speed to adjust a skew of the print media. For example, the first omni wheel and the second omni wheel may operate at different rotational speeds to adjust a skew of the print media. To illustrate, if the first omni wheel is on the inboard side and the second omni wheel is on the outboard side, rotating the first omni wheel faster than the second omni wheel may adjust a skew of the print media towards the inboard side. Similarly, rotating the second omni wheel faster than the first omni wheel may adjust a skew of the print media towards the outboard side.

In one embodiment, some of the omni wheels may have a same rotational speed. For example, the third omni wheel and the fourth omni wheel may rotate at the same speed to move the print media laterally without affecting the skew of the print media. The third omni wheel and the fourth omni wheel may be deployed to replace a movable carriage that is used in currently designed registration systems.

Using the numerical example in block 506, the motor of the first omni wheel may be controlled to rotate the first omni wheel faster in the process direction than the second omni wheel. Thus, the print media may be pulled towards the inboard side to correct the skew back to 0 degrees. The third omni wheel and the fourth omni wheel may be moved at the approximately same speed to laterally move the print media 0.5 mm towards the registration edge.

As a result, the omni wheels of the present disclosure may provide a more efficient design for handling print media within the registration system of a printing device. For example, the omni wheels may be deployed and configured to correct both skew and lateral position of the print media. At block 510, the method 500 ends.

It should be noted that the blocks in FIG. 5 that recite a determining operation or involve a decision do not necessarily require that both branches of the determining operation be practiced. In other words, one of the branches of the determining operation can be deemed as an optional step. In addition, one or more steps, blocks, functions or operations of the above described method 500 may comprise optional steps, or can be combined, separated, and/or performed in a different order from that described above, without departing from the example embodiments of the present disclosure.

FIG. 6 depicts a high-level block diagram of a computer that is dedicated to perform the functions described herein. As depicted in FIG. 6, the computer 600 comprises one or more hardware processor elements 602 (e.g., a central processing unit (CPU), a microprocessor, or a multi-core processor), a memory 604, e.g., random access memory (RAM) and/or read only memory (ROM), a module 605 for controlling a position of a print media in a registration system of a printing device via at least one omni wheel, and various input/output devices 606 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computer may employ a plurality of processor elements.

It should be noted that the present disclosure can be implemented in software and/or in a combination of software and hardware deployed on a hardware device, a computer or any other hardware equivalents (e.g., the registration system 106). For example, computer readable instructions pertaining to the method(s) discussed above can be used to configure a hardware processor to perform the steps, functions and/or operations of the above disclosed methods. In one embodiment, instructions and data for the present module or process 605 for controlling a position of a print media in a registration system of a printing device via at least one omni wheel (e.g., a software program comprising computer-executable instructions) can be loaded into memory 604 and executed by hardware processor element 602 to implement the steps, functions or operations as discussed above in connection with the example method 500. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 605 for controlling a position of a print media in a registration system of a printing device via at least one omni wheel (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A registration system for a printing device, comprising:
at least one sensor to detect a position of a print media fed from a feeder module;
a first omni wheel and a second omni wheel arranged such that a respective center axis of rotation of the first omni wheel and the second omni wheel are perpendicular to a process direction;
a first motor coupled to first omni wheel and a second motor coupled to the second omni wheel;
a third omni wheel and a fourth omni wheel arranged such that a respective center axis of rotation of the third omni wheel and the fourth omni wheel are parallel to the process direction;
a third motor coupled to the third omni wheel and a fourth motor coupled to the fourth omni wheel, wherein the at least one sensor is located upstream from the first omni wheel, the second omni wheel, the third omni wheel, and the fourth omni wheel; and
a processor communicatively coupled to the at least one sensor, the first motor, the second motor, the third motor, and the fourth motor, wherein the processor calculates a desired movement of the first motor, the second motor, the third motor, and the fourth motor to move the first omni wheel, the second omni wheel, the third omni wheel, and the fourth omni wheel based on the position of the print media to align the print media with an imaging module that prints a desired image onto the print media.

2. (canceled)

3. The registration system of claim 1, wherein the first omni wheel and the second omni wheel are positioned along a common center axis of rotation.

4. The registration system of claim 3, wherein a distance between the first omni wheel and the second omni wheel is approximately equal to a width of the print media.

5. The registration system of claim 1, wherein the first omni wheel, the second omni wheel, the third omni wheel, and the fourth omni wheel are located on a same side of the print media.

6. The registration system of claim 5, wherein a respective idler roller is positioned over the first omni wheel, the second omni wheel, the third omni wheel, and the fourth omni wheel on an opposite side of the print media.

7. The registration system of claim 1, wherein the first omni wheel and a second omni wheel are on a first side of the print media and the third omni wheel and the fourth omni wheel are on a second opposite side of the print media.

8. The registration system of claim 7, wherein the third omni wheel is located over the first omni wheel and the fourth omni wheel is located over the second omni wheel.

9. The registration system of claim 1, wherein the desired movement comprises a speed of rotation of the first omni wheel, the second omni wheel, the third omni wheel, and the fourth omni wheel.

10. The registration system of claim 9, wherein an amount of the desired movement is based on at least one of: a skew of the print media or a lateral position of the print media relative to a desired alignment position.

11. The registration system of claim 9, wherein the first omni wheel, the second omni wheel, the third omni wheel, and the fourth omni wheel each comprise:
a central body portion that rotates around the respective center axis of rotation; and
a plurality of roller components coupled to an outer periphery of the central body portion, wherein each one of the plurality of roller components rotate around an axis that is perpendicular to the respective center axis of rotation.

12. A method for controlling a position of a print media in a registration system of a printing device via at least one omni wheel, comprising:
detecting a position of a print media fed from a feeder module, wherein the at least one sensor is located upstream from a first omni wheel, a second omni wheel, a third omni wheel, and a fourth omni wheel;
determining a desired movement of the first omni wheel, the second omni wheel, the third omni wheel, and the fourth omni wheel based on the position of the print media, wherein the first omni wheel and the second omni wheel rotate in a process direction and the third omni wheel and the fourth omni wheel rotate perpendicular to the process direction; and
moving the first omni wheel, the second omni wheel, the third omni wheel, and the fourth omni wheel in accordance with the desired movement to adjust the position of the print media to align the print media with an imaging module that prints a desired image onto the print media.

13. The method of claim 12, wherein the position is detected via at least one sensor located upstream from the first omni wheel, the second omni wheel, the third omni wheel, and the fourth omni wheel.

14. The method of claim 12, wherein the position comprises a skew and a lateral position of the print media relative to a desired alignment position.

15. The method of claim 14, wherein the desired movement comprises a speed of rotation of the first omni wheel, the second omni wheel, the third omni wheel, and the fourth omni wheel.

16. The method of claim 15, wherein the speed of rotation of the first omni wheel, the second omni wheel, the third omni wheel, and the fourth omni wheel is different.

17. The method of claim 15, wherein the desired movement comprises an amount of movement to correct the skew and the lateral position of the print media.

18. The method of claim 12, wherein the moving comprises:
activating a respective motor coupled to the first omni wheel, the second omni wheel, the third omni wheel, and the fourth omni wheel.

19. A registration system for a printing device, comprising:
a charge coupled device (CCD) sensor to detect a lateral position relative to a designed alignment location and a skew of a print media fed from a feeder module;
a first omni wheel and a second omni wheel arranged to rotate along a process direction around a respective center axis of rotation of the first omni wheel and the second omni wheel;
a first motor coupled to first omni wheel and a second motor coupled to the second omni wheel to rotate the first omni wheel and the second omni wheel in along the process direction;
a third omni wheel and a fourth omni wheel arranged such to rotate perpendicular to the process direction around a respective center axis of rotation of the third omni wheel and the fourth omni wheel, wherein the CCD sensor is located upstream from the first omni wheel, the second omni wheel, the third omni wheel, and the fourth omni wheel;
a third motor coupled to the third omni wheel and a fourth motor coupled to the fourth omni wheel to rotate the third omni wheel and the fourth omni wheel in perpendicular to the process direction; and
a processor communicatively coupled to the CCD sensor, the first motor, the second motor, the third motor, and the fourth motor, wherein the processor calculates an amount of desired movement of the first motor, the second motor, the third motor, and the fourth motor to correct the skew and the lateral position of the print media, wherein rotation of the third omni wheel and the fourth omni wheel correct the lateral position and rotation of two or more of the first omni wheel, the second omni wheel, the third omni wheel, and the fourth omni wheel correct the skew of the print media to align the print media with an imaging module that prints a desired image onto the print media.

20. The registration system of claim 19, wherein the first omni wheel, the second omni wheel, the third omni wheel, and the fourth omni wheel each comprise:
a central body portion that rotates around the respective center axis of rotation; and
a plurality of roller components coupled to an outer periphery of the central body portion, wherein each one of the plurality of roller components rotate around an axis that is perpendicular to the respective center axis of rotation.
